(19) United States
(12) Patent Application Publication
(10) Pub. No.: US 2002/0084173 A1
(43) Pub. Date: Jul. 4, 2002

(54) Motorized roller conveyor system with modular control system

(76) Inventor: Robert W. Paquette, Grand Prairie, TX (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/034,568

(22) Filed: Dec. 27, 2001

Related U.S. Application Data
(60) Provisional application No. 60/258,990, filed on Dec. 29, 2000.

(51) Int. Cl. B65G 13/06

(52) U.S. Cl. 198/781.06

(57) ABSTRACT

A modular conveyor system includes a first conveyor module having a selectively actuable device for transporting a product. The first conveyor module may include a drive roller connected to idler rollers, a sensor for sensing a product, and a programmable controller responsive to detection signals from the sensor for controlling operation of the actuable device according to a programmed logic scheme. The second conveyor module includes a plurality of selectively actuable active zones for transporting a product, each active zone comprising a drive roller connected to multiple idler rollers, sensors associated with each active zone, and a non-programmable controller responsive to detection signals from the sensors to control the movement of items in the zones. The conveyor modules may include different types of controller motherboards that communicate with other motherboards using different types of communications systems such as an ASI bus, a CAN bus, or other types.

### CROSS REFERENCE TO RELATED APPLICATIONS

This application claims priority to U.S. provisional application serial No. 60/258,990 filed Dec. 29, 2000 and bearing the same title.

### BACKGROUND OF INVENTION

The invention relates to controls for modular conveyors and modular conveyor systems such as modular roller-type conveyor systems.

Modular conveyors, and in particular, roller-type modular conveyors, are known in the art. For example, U.S. Pat. No. 5,582,286 issued Dec. 10, 1996, to Kalm et al., the disclosure of which is incorporated herein for all purposes, discloses a modular power roller conveyor comprising a number of active zones, each with a sensor for sensing the entry of a product item into the active zone. A programmable controller activates the active zone in response to a signal from the sensor and also generates a deactivation signal to deactivate the active zone as a product item exits the zone.

However, there exists a need for an improved control system that provides greater flexibility in accepting controls suited for the particular application. For example, many controls must be designed specifically to be compatible with the end user's particular type of network and programming hardware. In some cases, this requires that networking wiring be installed on the conveyor at the installation site, requiring additional installation time and effort. In a given application it may be necessary in some locations to have the capability to program the controls for a given module whereas in other locations in the same application, programmable controls are not required.

Thus, there exists a need for a control system that provides the flexibility necessary to allow complete factory assembly of the conveyor modules while simultaneously providing “plug and play” field installation.

### SUMMARY OF THE INVENTION

The modular control system of the invention provides a system and method for controlling a plurality of roller type conveyor modules arranged in an application specific configuration. In one embodiment, a first conveyor module includes a plurality of selectively actuable devices for transporting a product unit. The first conveyor module is provided with a sensor for sensing a product unit and for generating a detection signal in response to the presence of a product unit. A programmable controller responsive to detection signals from the sensor controls operation of the actuable device according to a programmed logic scheme. A second conveyor module includes a plurality of selectively actuable active zones for transporting a product unit. Sensors associated with each active zone of the second module detect product units in the active zone and generate detection signals in response. A non-programmable controller responsive to detection signals from one or more of the sensors implements logic to pass an item from one active zone to the next active zone.

In another embodiment, a single, integrated, modular control unit for a roller type conveyor including at least one active zone is provided. The modular controller includes a motherboard with a plurality of daughterboards disposed on the motherboard, including at least one motor control board for controlling an active zone of the roller type conveyor. An I/O daughterboard for interfacing with peripheral equipment may be included on the motherboard as well as a communications interface and a microprocessor. The modular controller controls all of the functions of the roller type conveyor in a single unit.

In another embodiment, a controller for a conveyor module is provided. The controller includes a motherboard adapted to control the movement of an article on the conveying surface based at least partially on information received from a sensor. A daughterboard is also included that is attached to the motherboard and that is adapted to communicate with a driver that drives the conveying surfaced based on instructions from the motherboard. The daughterboard is configured to be physically and electrically attached to either a first or second type of motherboard.

According to still another embodiment, a conveyor system is provided that includes a plurality of first conveyor modules. Each module includes a controller adapted to control the movement of articles on the respective first conveyor modules. Each of the controllers is adapted to communicate with another first conveyor module controller via a first type of communications bus. A plurality of second conveyor modules are also provided wherein each second conveyor module has a controller adapted to control the movement of articles on the respective second conveyor modules. Each of the second conveyor controllers is adapted to communicate with other second conveyor controllers via a second type of communications bus.

In other aspects of the invention, the various types of communications busses may include Actuator Sensor Interface (ASI) busses and Controlled Area Network (CAN) busses. The programmable controllers may comprise an integral modular unit including a motor control board for controlling actuation of each drive roller of the first module, an I/O board for receiving signals from the detection devices and a communications interface. The non-programmable controllers may be incorporated into circuitry built together with the motor control circuitry, these controllers being interconnected to form a modular control unit that controls the active zones of the second module according to a predetermined logic scheme. The first conveyor modules may include a divert mechanism which can be selectively actuated to cause an item on the main path to be diverted to a divert path, and a programmable controller that controls the operation of the divert mechanism. A sensing device such as a bar code scanner may also be positioned to scan an item before the item reaches the divert branch of the first module to determine whether an item should be diverted, the scanner being connected to the programmable controller and signaling the programmable controller to divert an item to the divert path or allow the item to pass along the main path. A pair of conveyor modules, one connected to receive items from the main path of the divert module and one connected to receive items from the branch, or divert path, of the first module may also be provided.

### BRIEF DESCRIPTION OF THE DRAWINGS

FIG. 1 is a perspective view of one section of a modular power roller conveyor suitable for use in connection with the invention;

FIG. 2 is a cross-section of the conveyor section of FIG. 1 taken along line II-II;

FIG. 3 is a top view of the section of a modular power roller conveyor of FIG. 1 with four active zones;

FIG. 4 is a perspective view of a curved section of a modular power roller conveyor suitable for use in connection with the invention;

FIG. 5 is a top view of a divert section of a modular power roller conveyor in which a divert arm is unactuated and positioned above a side rail;

FIG. 6 is a side view of the divert section of FIG. 5 in which the divert arm is unactuated;

FIG. 7 is a top view of the divert section of FIG. 5 in which the divert arm is actuated and positioned in the path of a product item moving along the conveyor;

FIG. 8 is a side view of the divert section of FIG. 6 in which the divert arm is actuated and positioned in the path of a product item moving along the conveyor;

FIG. 9 is a block diagram of modular control units, illustrating combinations of the modules;

FIG. 10 is a diagram of a modular programmable Distributed Control MotherBoard (DCMB) according to one embodiment of the present invention;

FIG. 11 is a diagram of a modular Central Control MotherBoard (CCMB) with an ASI bus network connection according to one aspect of the present invention;

FIG. 12 is a diagram of a modular Brushless Motorized Roller DaughterBoard (BLMRD);

FIG. 13 is a diagram of a modular Brush Type Motorized Roller DaughterBoard (BTMRDB);

FIG. 14 is a diagram of a modular Digital I/O DaughterBoard (DIODB);

FIG. 15 is a block diagram of one embodiment of a modular control system utilizing non-programmable zone logic embedded in the control devices;

FIG. 16 is a schematic representation of an illustrative conveyor system utilizing a control system of the invention.

FIG. 17 is a plan view of a conveyor section with pivotable motor wheels;

FIG. 18 is a plan view of a merge conveyor section;

FIG. 19 is a plan view of a right angle conveyor divert section;

FIG. 20 is a perspective view of a first type of motherboard and housing;

FIG. 21 is a perspective view of a second type of motherboard and housing;

FIG. 22 is a perspective view of five daughterboards attached to the first motherboard; and

FIG. 23 is a perspective view of the housing of FIG. 20 shown with end plates attached.

### DETAILED DESCRIPTION

As used herein, the term “zone logic” refers to instructions that are used to control active zones of a modular roller conveyor and, in particular, instructions to provide for passing an item from one zone to the next, deactivating zones which do not contain an item and accumulating items in a zone when the next zone in the direction of transport already contains a product item. As will be appreciated, “zone logic” may be programmed into a programmable control device such as a PLC or built into the circuitry of a device such as a zone controller.

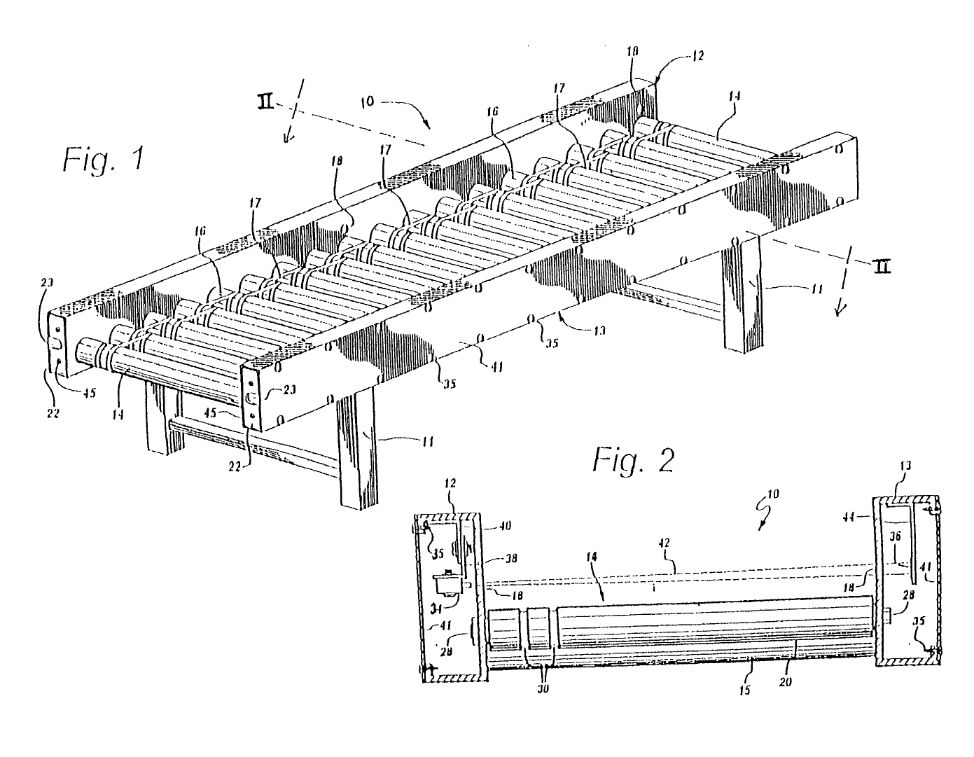

Referring now to the drawings in which like reference numerals denote the same or similar parts and in particular FIG. 1, there is shown a conveyor module or section 10 suitable for transporting products along a defined path. The module 10 comprises a straight conveyor section supported by legs 11 and includes a left side rail 12, a right side rail 13, a plurality of idler rollers 14 and drive rollers 16 mounted between the left side rail 12 and the right side rail 13. Drive rollers 16 may be of the brush type or brushless type motor design. The idler rollers 14 and drive rollers 16 are linked with O-ring bands 17 so that operation of a driver roller will cause rotation of any idler rollers connected thereto with an O-ring band.

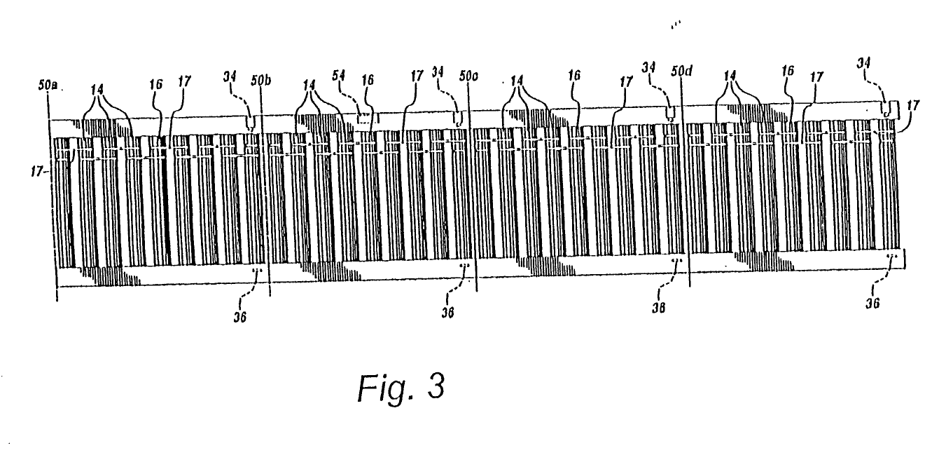

Drive rollers 16 are preferably twenty-four volt electric conveyor rollers and include internal gearing and an electric motor. The drive rollers 16 may be of the type manufactured by ITOH Electric or Kyowa Manufacturing Co. Side rails 12 and 13 have a cross-sectional shape that defines a raceway for placement of power and control conductors (FIG. 2). Side rails 12 and 13 are provided with a plurality of openings 18 to facilitate the operation of photosensors and reflectors. Side rails 12 and 13 are provided with internal connecting brackets 22 at each end of the conveyor section 10 with holes 45 for fasteners to enable the conveyor section 10 to be interconnected with other conveyor sections to form a conveyor system. An electrical connector 23 is provided on each end of side rails 12 and 13 to allow for electrical interconnection of adjacent modules for control or power purposes.

Referring now to FIG. 2, idler roller 14 is mounted between side rails 12 and 13. Idler roller 14 is equipped with a spring loaded shaft 28 to facilitate installation of the roller in the side rails. As shown, each idler roller includes a pair of grooves 30 for placement of O-ring bands 17. A photosensor 34 is mounted within side rail 12 on a sensor bracket 38 which is in turn mounted to the side rail with an upper support bracket 40. The photosensor 34 is positioned so that a beam 42 from the photosensor passes through opening 18 and travels laterally over conveyor section 10, striking reflector 36 mounted in side rail 13. The beam is reflected back to photosensor 34 where it is detected, triggering a detection signal. Although, as illustrated and described, a photosensor is used to generate the detection signal, alternative sensing devices such as proximately switches, motion detectors, weighing devices such as scales, bar code scanners, color detectors, laser sensing devices, magnetic readers or sensing devices and other sensing devices that detect the presence of an item or a property of an item, (such as motion or weight) and which may be used to generate a detection signal may be utilized in connection with the invention.

Turning now to FIG. 3, there is shown a top view of conveyor section 10 including four active zones 50a-50d. Each active zone includes a drive roller 16 with a plurality of idler rollers 14 slaved to the drive roller 16 with O-ring bands 17. Each active zone is provided with a photosensor 34 and reflector 36 located adjacent to the entry end 52 of the active zone.

In one embodiment, as a product unit leaves one active zone, the product unit breaks light beam 42 (FIG. 2) between photosensor 34 and reflector 36, adjacent to the entry end of the next active zone, causing a detection signal to be transmitted to a controller 54, that may be mounted in a side rail. Controller 54 then activates the next zone as the product unit enters the zone. For example, a product unit leaving active zone 50a would break the light beam adjacent to the entry end of active zone 50b, generating a detection signal received by controller 54 which would activate zone 50b. Simultaneously, the controller 54 will deactivate active zone 50a, minimizing noise and power consumption. As set forth in detail below, an active zone may be controller with a modular programmable controller or may be equipped with a modular non-programmable control system for implementing zone logic.

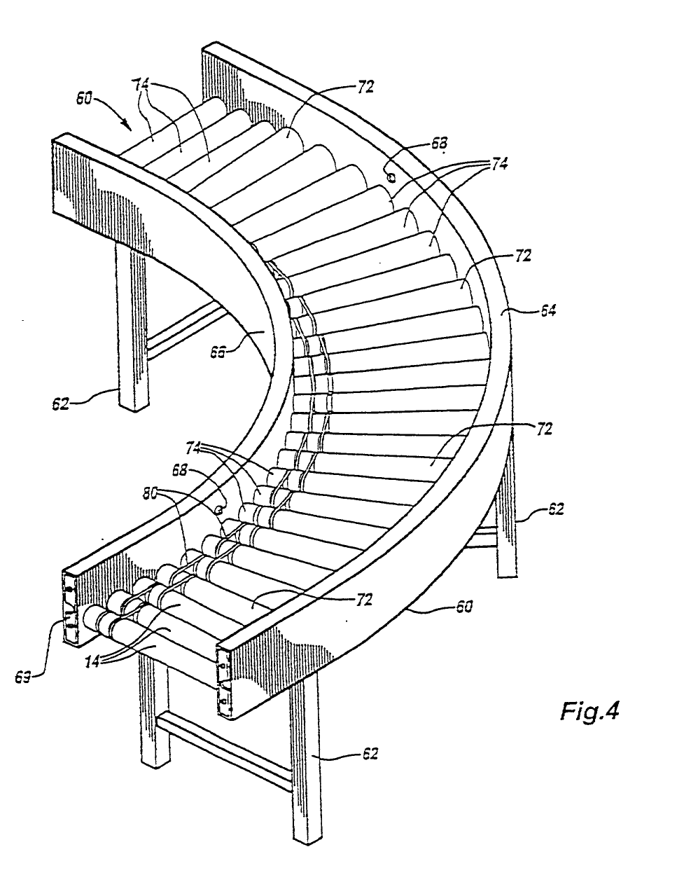

Referring now to FIG. 4, there is illustrated a curved module or section 60 of a power roller conveyor suitable for use with the invention. As illustrated, the module 60 traverses an arc of 90°; however, as will be appreciated, modules with varying curvatures ranging from 0° to 180° may be readily constructed. As illustrated, module 60 is supported with legs 62 and includes side rails 64 and 66 along with drive rollers 72 and idler rollers 74 mounted between side rails 64 and 66. Drive rollers 72 and carrier rollers 74 are operably connected with O-ring bands 80 so that actuation of a drive roller 72 will also actuate connected idler rollers 74. Side rails 64 and 66 are provided with holes or apertures 68 to facilitate the operation of photosensors 34 and reflections 36 (FIG. 2) in the same fashion as discussed in connection with FIG. 2. An electrical connector 69 is provided on each end of side rail 66 to allow for electrical interconnection of adjacent modules for control power purposes.

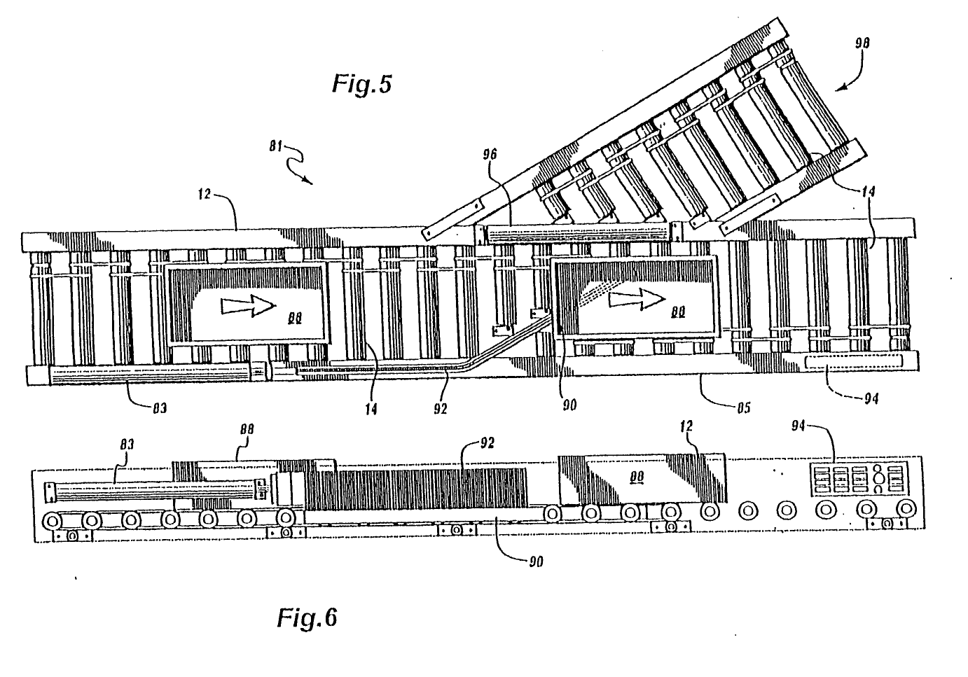

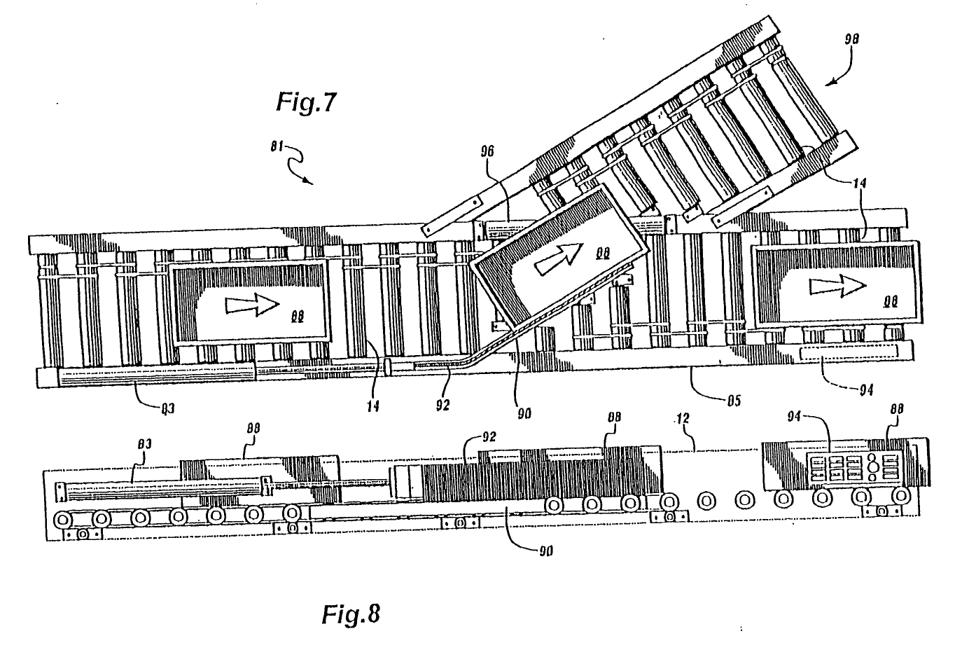

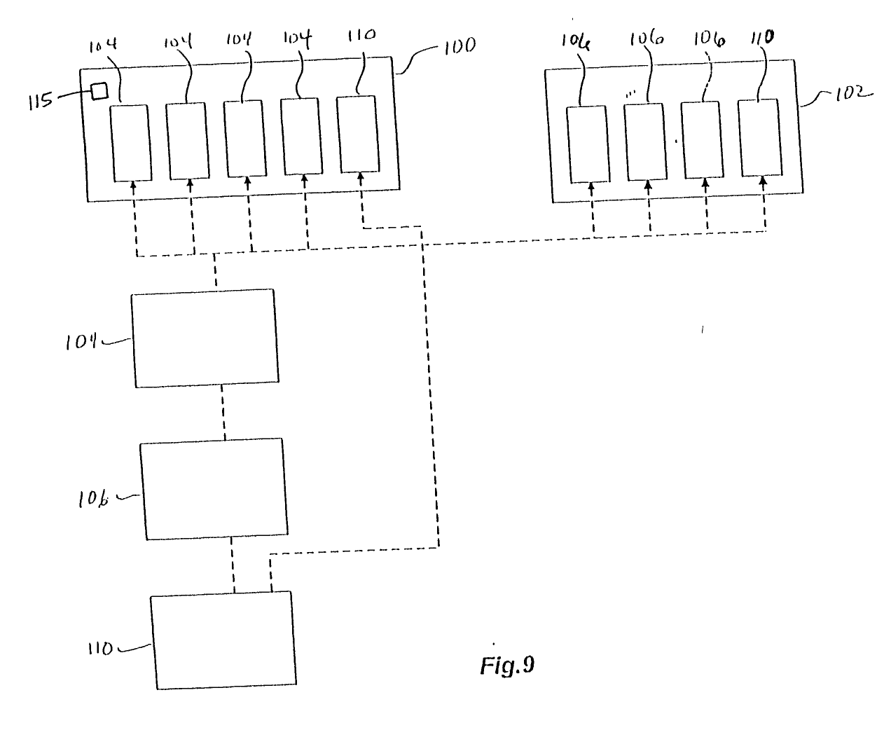

Referring now to FIGS. 5-8 in conjunction, there is illustrated a divert module or section 81 of a power roller conveyor. As illustrated in FIG. 5, the divert section is in its unactuated state and a product item 88 travels straight across the divert section to the next adjacent module in the direction indicated by the arrow. The divert section 81 includes a cylinder 83 and flexible divert arm 92 mounted to side rail 85. Activation of cylinder 83 extends the flexible divert arm 92 from side rail 85 across divert section 81 to divert a product item (FIG. 7). A track 90 located in the plane defined by the surface of the rollers compromises a narrow groove that serves as a guide for the flexible divert arm 92. The track extends obliquely from the side rail 85 to the limit of extension of the flexible arm 92. Thus, when cylinder 83 is actuated, the divert arm 92, the bottom edge of which engages track 90, slides along side rail 85 and track 90 into the path of product items 88 moving along the conveyor. Product items traveling along the divert section 81 encounter the extended divert arm 92 and slide along the divert arm 92 onto a straight section 98 positioned at an angle to the divert section 81. The operation of the divert section 81 is controlled by a programmable controller 54.

As shown, divert section 81 is left-handed, i.e., designed to divert articles to the left. However, it will be appreciated that other variants including right-handed divert sections could readily be constructed. Other variants of the divert section could employ a divert arm or arms that move vertically, into and out of the path of articles moving along conveyor section 81.

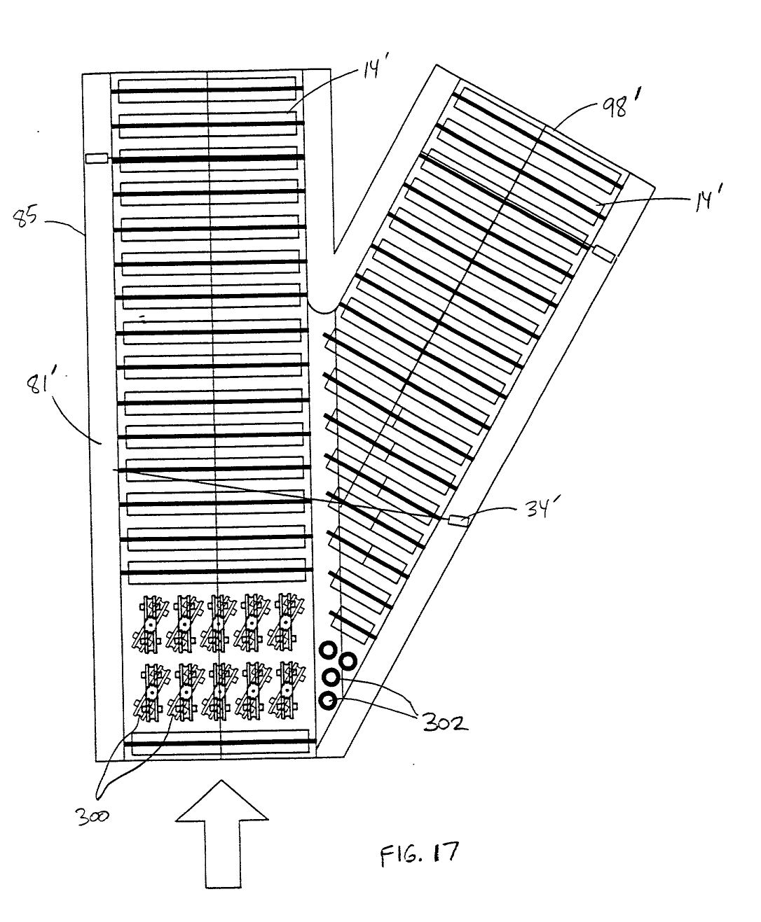

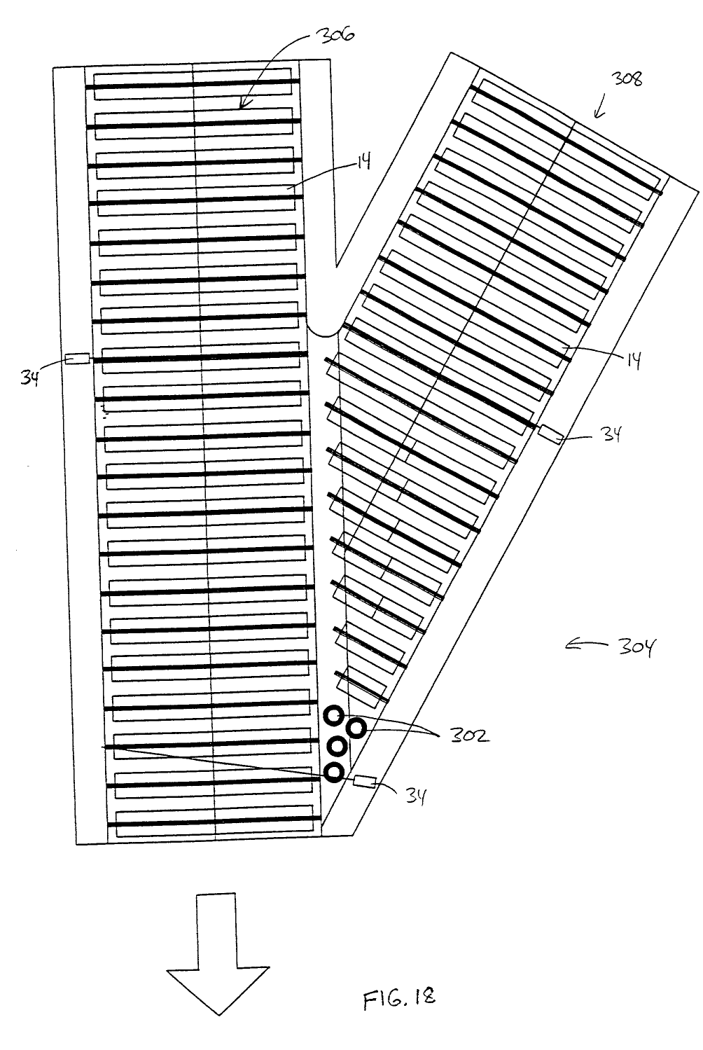

Another type of divert section 81′ is depicted in FIG. 17 in which similar components to divert section 81 are identified by the same number followed by a prime symbol (′). Divert section 81′ includes a plurality of pivotable wheels 300 that pivot to either direct items to divert section 98′ or allow them to continue moving straight on section 81′. The pivoting may be controlled by a solenoid (not shown). A plurality of roller balls 302 may be included adjacent the wheels 300 to provide surface support for conveyed items. The operation of the wheels 300 may be controlled by a controller 54.

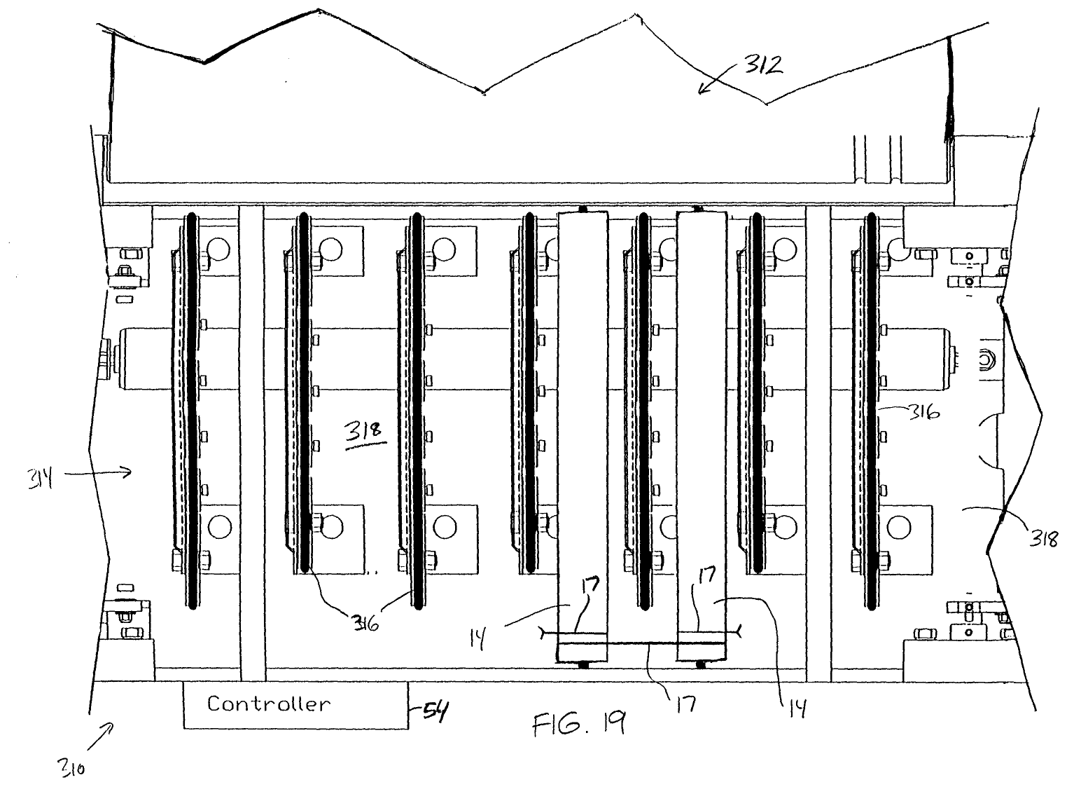

The present invention also finds equal application to merge and right angle divert modules or sections, such as are illustrated in FIGS. 18 and 19, respectively. The merge section 304 includes a main conveyor section 306 and a merging branch 308. A plurality of sensors 34 are included at the upstream end of the sections 304 and 306. Another sensor 34 is positioned at the downstream end of the merge. The sensors 34 provide signals indicative of the presence or absence of articles on merge section 304 to a controller 54 (not shown). The controller issues signals to appropriate drive rollers to enable items from conveyors 306 and 308 to properly merge.

An illustrative example of a right angle divert 310 is depicted in FIG. 19. Right angle divert diverts articles onto a conveyor section 312 that is oriented at a right angle to the main conveyor section 314 of divert 310. Divert 310 includes a plurality of rollers 14, only two of which are shown that are activated when an item is not to be diverted onto branch 312. A plurality of motorized roller belts 316 are disposed between rollers 14 and at a lower plane than rollers 14. Roller belts 316 are vertically movable (into and out of the page of FIG. 19). When an article is to be diverted, roller belts 316 are moved upwardly (out of the plane of FIG. 19) until they contact the underside of the item to be diverted. They continue to lift the item until it reaches a height above rollers 14. The movement of roller belts 316 is controlled by a pop-up plate 318 to which the roller belts 316 are mounted. Control of the diverting can be carried out by a controller 54 in accordance with the present invention.

Referring now to FIG. 9, exemplary components of the control system of the invention are illustrated as assembled. A programmable Distributed Control MotherBoard (DCMB) 100 comprises a Micro Programmable Logic Controller conforming with IEC1131-1. The DCMB contains both Controller Area Network (CAN) communications or interfaces as well as the Central Processing Unit (CPU). Each CAN node has 5 I/O slots designated to accept a family of motorized roller and general purpose I/O daughterboards. The DCMB 100 includes external connections for a CAN bus port, RS-232C port and 24VDC power source. DCMB 100 also contains onboard input circuitry for four photoelectric sensors with health outputs. DCMB 100 may be programmed via the RS-232C port with a PC. DCMB 100 may be programmed with zone logic, i.e., instructions to control each active zone in a particular manner depending upon signals received by sensors such as photocells and may also be programmed with instructions for controlling a more complex device, such as an angled divert, a merge, or a right angle divert, based upon signals received from sensing devices such as scales, bar code scanners or magnetic label readers.

DCMB 100 is configured to receive a variety of daughterboards, including brushless type motorized roller daughterboards 104, brush type motorized roller daughterboards 106 and a digital I/O daughterboard 110.

A second motherboard configuration is a Central Control MotherBoard (CCMB) 102 that contains Application Specific Integrated Circuit (ASIC) circuitry for two ASI slave devices. Each ASI slave device address four input bits and four output bits. The CCMB 102 is configured to accept up to four daughterboards which may include a brushless type motorized roller daughterboard 104, a brush type motorized roller daughterboard 106 and a digital I/O daughterboard 110. The CCMB 102 also contains onboard input circuitry for four photoelectric sensors with health outputs. The CCMB is controlled along with other CCMB modules on an ASI network by a type of zone logic as described above.

DCMB 100 and CCMB 102 are each programmable or adaptable to respond to detection signals from sensors such as a photosensor or scanner to control the operation of a plurality of active zones of modular conveyors such as illustrated in FIGS. 1-8 according to a logic scheme. Sensor inputs may be accommodated with an I/O daughterboard, and individual motor control is accomplished via brushless or brush type motor control boards. The modular design of DCMB 100 and CCMB 102 allows the controllers to be installed on a conveyor module prior to shipment, thus allowing “plug and play” installation on site.

Each Brushless Type Motorized Roller Daughter Board (BLMRDB) 104 is configured to control one 24 VDC brushless type motorized roller. BLMRDB 104 is capable of operating the motor in either direction and dynamically braking the roller while also providing adjustable speed control. The BLMRDB is configured to interconnect with either a DCMB 100 or CCMB 102 using a universal header pin interface. Digital I/O daughterboards are configured with 2 inputs (sinking or sourcing) and 2 outputs (sinking, sourcing or relay).

Brush Type Motorized Roller Daughter Board (BTMRDB) 106 is configured to control one 24 VDC brush type motorized roller. The BTMRDB includes a controller capable of operating the motor in either direction and providing adjustable speed control. The BTMRDB is configured to interconnect with either a DCMB 100 or CCMB 102 using a universal header pin interface 130.

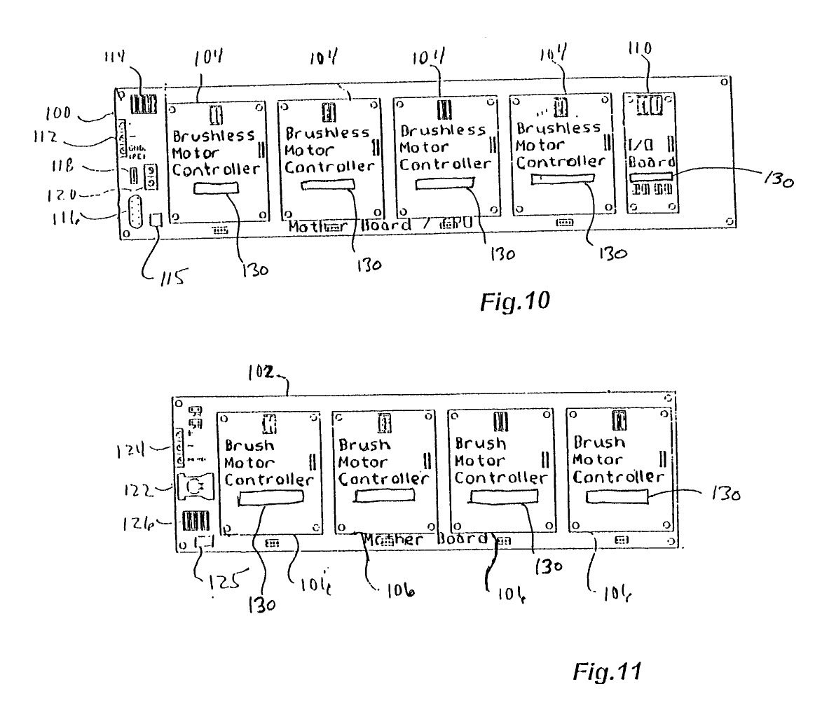

As will be appreciated, DCMB 100 or CCMB 102, BTMRDB 104 and I/O daughterboard 110 are each modular components that may be combined in a number of different ways to provide application specific control with the advantages of a plug-and-play system. For example, turning to FIG. 10, a possible configuration for DCMB 100 is illustrated. As shown, DCMB 100 is configured with a microprocessor 115 described above, four BLTMRDE 104 brushless control boards and DIODB 100. DCMB 100 includes 24 VDC power connectors 112, LED display indicators 114, CAN interface 118, CAN bus node address switches 120 and an RS232C port 116.

A possible configuration for CCMB 102 is shown in FIG. 11. CCMB 102 is configured with four BTMRDB 106 control boards. CCMB 102 includes ASI bus connection 122, 24 VDC power connectors 124 and LED display indicators 126. DCMB 100 and CCMB 102 are adapted to receive a combination of BLMRDB 104 brushless control boards, BTMRDB 106 control boards and a DIODB 110.

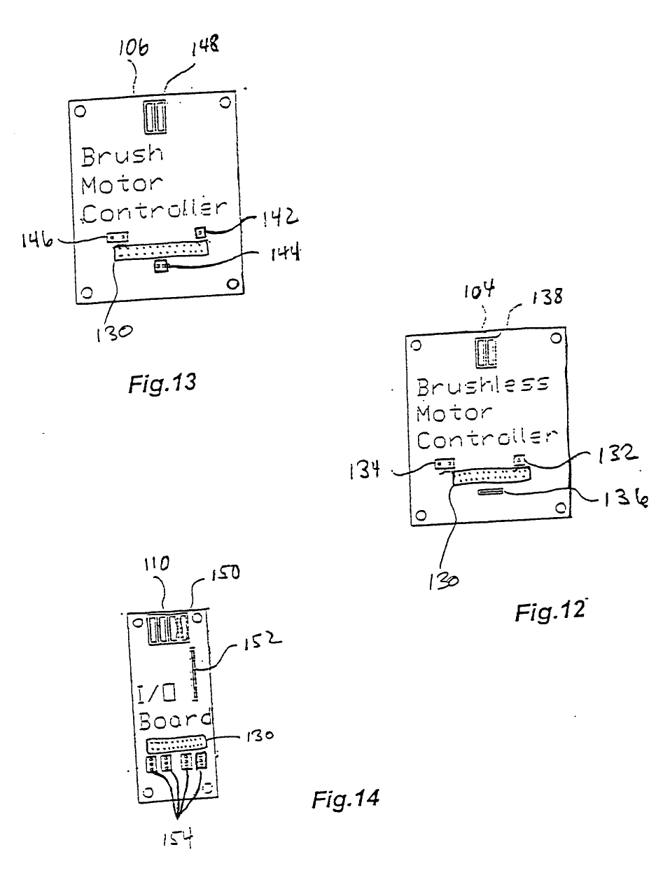

Turning now to FIGS. 12-14 a BLMRDB 104, BTMRDB 106 and DIODB 110 suitable for use in connection with the invention are illustrated in greater detail. Turning to FIG. 12, BLMRDB 104 includes a universal header pin interface 130, speed control switch 132, motor connector 136 and motor reverse switch 134. BLMRDB 104 also includes LED indicators 138.

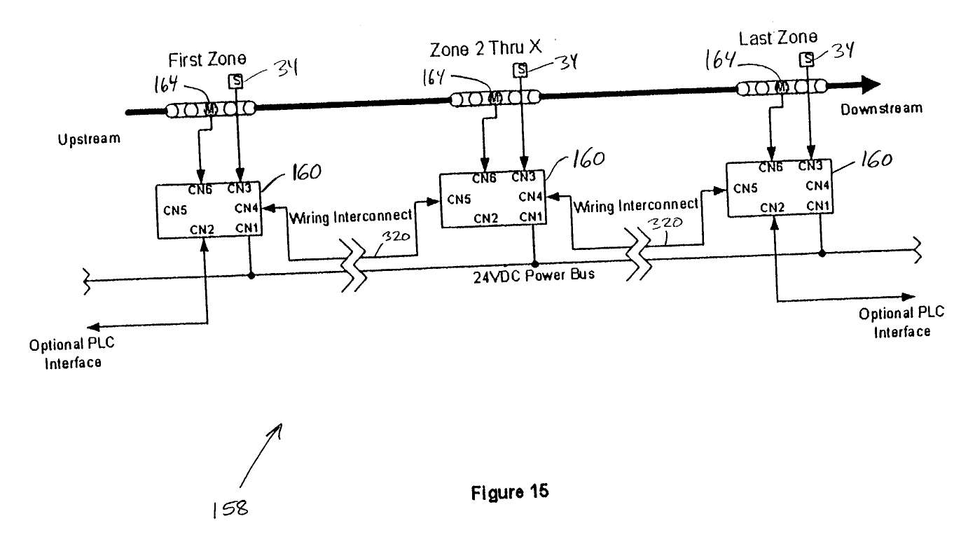

Referring now to FIG. 13, a BTMRDB 106 is illustrated. BTMRDB 106 includes a universal header pin interface 130, speed control switch 142, motor connector 144, motor reverse switch 146 and LED indicators 148. As illustrated in FIG. 14, DIODB 110 includes I/O LED status indicators 150, motherboard connector 152 and I/O connectors 154. I/O board 110 receives signals from sensors and sensing devices, such as photocells, photosensors, scales, scanner and readers. Signals received by DIODB 110 motherboard are utilized by a motherboard DCMB 100 or CCMB 102 in conjunction with programmed instructions to control the operator of a conveyor module or modules.

Turning now to FIG. 15, another option for controlling the operation of a conveyor section 10 is schematically illustrated. As illustrated, the control system 158 includes zone controllers 160. Each zone controller 160 connects to a photosensor 34 and motorized roller 164 for controlling the operation of an active zone (FIG. 3) of a conveyor module 10. The controller 160 detects the presence or absence of a product unit on or adjacent to the associated active zone. These single zone controllers 160 include a non-programmable control unit for the active zone providing for control of the operation of a drive roller motor 164. The controllers 160 respond to detection signals and implement zone logic to pass an item from one end of the module to the other, to deactivate a zone when an item to transport is not present, and to accumulate an item in a zone when the next zone in the direction of transport already contains a product item. As illustrated, each controller 160 is interconnected to adjacent controllers with connectorized cables 320. The interconnected assemblies comprise a non-programmable modular control unit for a conveyor module, controlling the functions and operations of the module according to a predetermined logic scheme.

As will be appreciated, the control system of FIG. 15 may be used in conjunction with other adjacent modules that are controlled via DCMB 100 or CCMB 102. Thus a product item traveling through a conveyor system may pass from a module controlled by a DCMB 100 or CCMB 102 to a module controlled by the non-programmable system illustrated in FIG. 15.

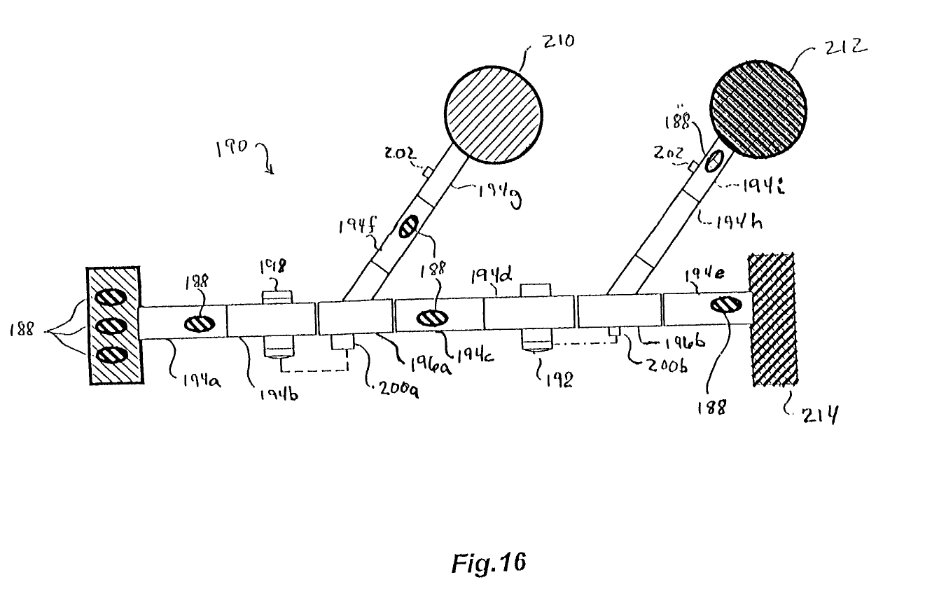

Turning now to FIG. 16, there is illustrated a conveyor system 190 utilizing a modular control system of the invention. As illustrated, conveyor system 190 includes a plurality of conveyor modules, each of which defines a substantially planar conveying surface contiguous with the conveying surface of the adjacent modules. Included in the system are a plurality of straight conveyor sections 194a-194i, two divert sections 196a and 196b, a loading station 190, sensing devices 198, product bins 210 and 212 and unloading station 214.

Product items 188 are received at a loading station 190 for distribution by the system. The product items are fed mechanically or manually onto a first straight conveyor module 194a. Product items are conveyed from conveyor module 194a to 194b and past a sensing device such as a scale 198 which determines whether a particular item is overweight and should be routed to a holding bin 210 for further processing. Scale 198 provides an output to a DCMB 200 which controls divert module 196a. Upon receiving a signal from scale 198 that an overweight item is about to enter the divert module 196a, DCMB 200a actuates the divert module to divert the item onto module 194f. The overweight item is conveyed along modules 194f and 194g to holding bin 210. As illustrated, conveyor module 194g is controlled by a CCMB 202 which activates and deactivates the active zones of the module (FIG. 3). In addition to activating and deactivating the active zone of conveyor module 194g, CCMB 202 may also be programmed to respond to external signals, for example, to shut down the module upon receiving a signal indicating that bin 210 is filled to capacity.

Items passing through divert module 196a travel across conveyor modules 194c and 194d and through or past a second sensor such as a bar code sensor 198 which identifies items addressed for delivery to bin 212. Alternatively, the second sensor could scan for color, tray style (if product items were being transported in trays), oversized items, magnetic labels or embedded microchips.

Upon identifying an item addressed to bin 212, bar code scanner 198 signals DCMB 200b which activates the divert module 196b to divert the article to travel across conveyor modules 194h and 194i and into bin 212. Remaining items 188 travel past divert module 196b to an unloading station 214.

As illustrated, conveyor module 194i is controlled with a CCMB 202 in the same manner as described above in connection with module 194g. In the embodiment illustrated in FIG. 16, a number of the modules may be controlled without the use of a programmable controller, for example, modules 194a, 194b, 194c, 194d, 194e, 194f and 194h may be controlled with a non-programmable control system 158 such as illustrated in FIG. 15, in which the logic for controlling the operation of each drive roller motor 164 (FIG. 15) is built into the sensor unit 160 for that active zone. Thus, as illustrated, the conveyor system 109 is equipped with a variety of modular controls, each selected for a particular task depending upon system requirements. The combination of programmable devices, i.e., DCMB 200 and CCMB 202 with non-programmable controls, i.e. system 158, provides a degree of flexibility in design and operation that is not provided by the use of a single type of control. Further, since the controls are modular, the system may be designed and installed with the convenience of a “plug-and-play” system while simultaneously providing an application specific system.

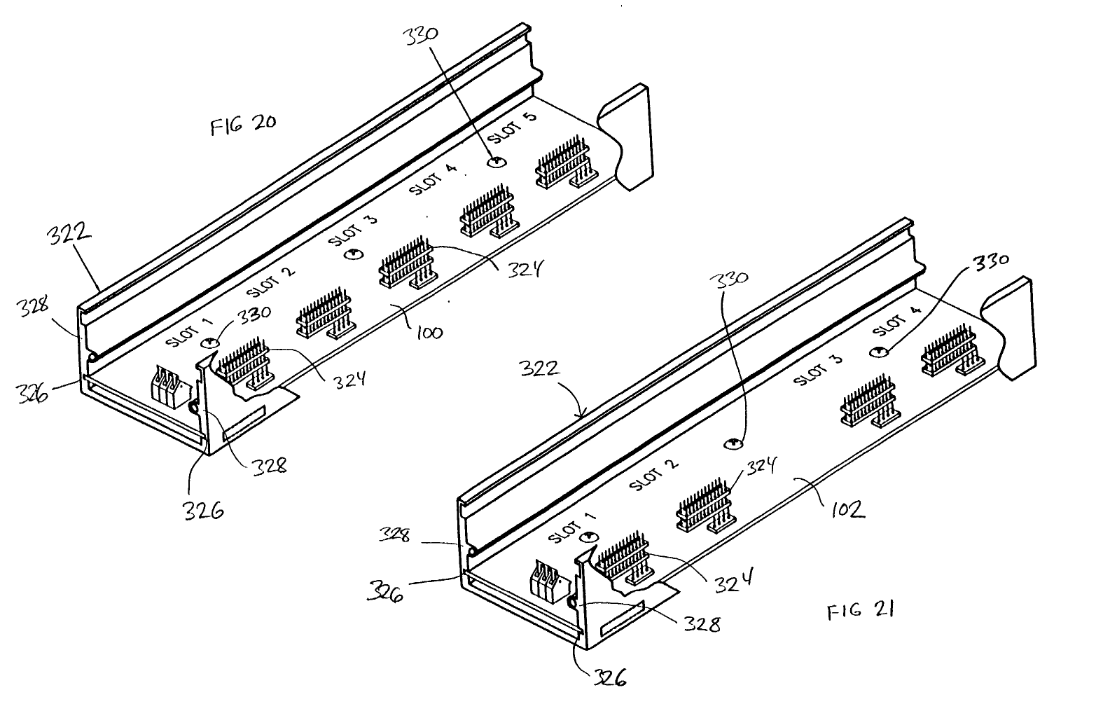

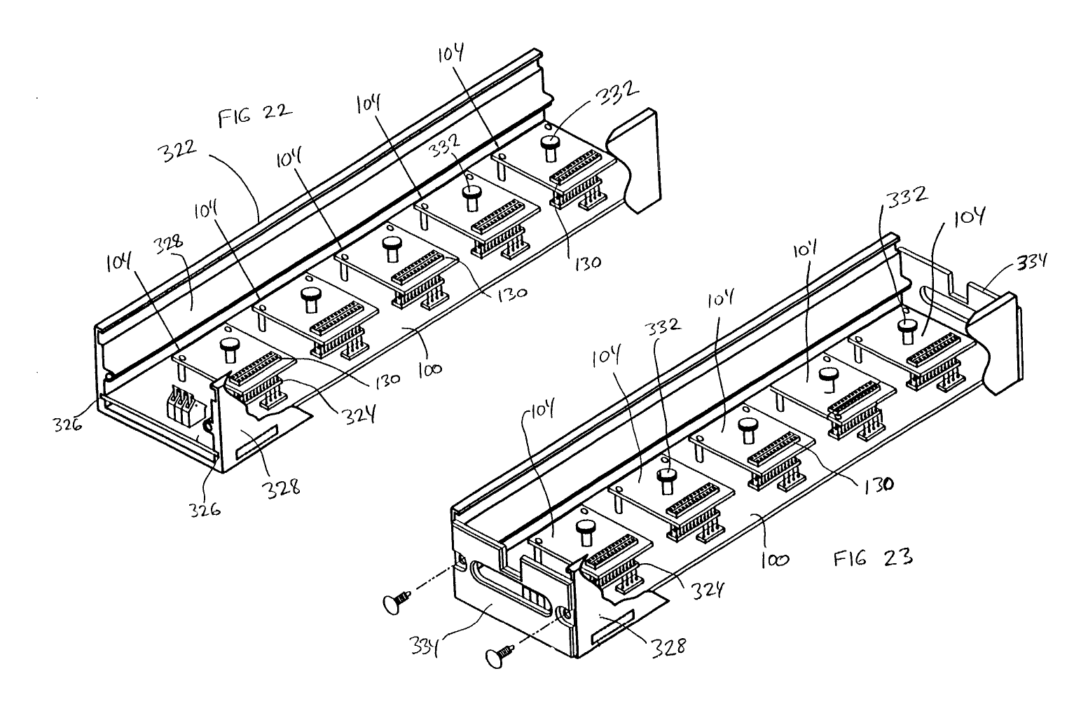

Referring to FIGS. 20-23, a housing 322 is depicted for either DCMB 100 or CCMB 102, as well a number of daughterboards. An illustrative example of a DCMB 100 is depicted in housing 322 in FIG. 20. An illustrative example of a CCMB 102 is depicted in housing 322 in FIG. 21. The daughterboards that may be added to each of the respective motherboards include any desirable combination of daughterboards 104, 106, and 110. An illustrative example of added daughterboards are depicted in FIGS. 22 and 23. The motherboards may have minor physical variations from those depicted in the other drawings, but their functionality remains the same as that described herein.

DCMB 100 and CCMB 102 each include sets of pin connectors 324 positioned and configured to interact with the universal header pin interfaces 130 on any of the daughterboards 104, 106, or 110. After a particular motherboard has been selected for a particular application, it is slid into a slot 326 defined in sidewalls 328 of housing 322. Thereafter, it is secured in place by one or more screws 330, or other types of fasteners.

After the selected motherboard has been inserted and secured in place, the selected daughterboards are attached on top of the motherboard, as illustrated in FIGS. 22 and 23 (Note daughterboard 104 has been selected for illustration purposes only). Each daughterboard may include a handle 332 to allow it to be physically manipulated more easily. The universal header pin interfaces 130 on the daughterboards mesh with the pin connectors 324 positioned on the motherboard to provide an electrical and physical connection between the motherboard and attached daughterboards. Due to universal header pin interfaces 130 and pin connectors 324, the same daughterboards can be attached to either DCMB 100 or CCMB 102 without any modifications, regardless of which type of motherboard is selected and inserted into housing 322. The daughterboards are thus universally applicable to the different motherboards, allowing the different types of motherboards to be easily incorporated into a conveyor module. Housing 322 can be positioned at any suitable location on its associated conveyor section. An endplate 334 may be attached by screws or other fasteners to each end of housing 332, as illustrated in FIG. 23.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims.

The embodiments of the present invention in which an exclusive property or privilege is claimed are defined as follows:

1. A conveyor system, comprising:
a first conveyor module including at least one selectively actuable device for transporting an item, at least one sensor, and a programmable controller responsive to detection signals from the sensor which controls operation of the actuable device according to a programmed logic scheme; and
a second conveyor module disposed adjacent to the first conveyor module for receiving a transported item therefrom, said second conveyor module including at least one selectively actuable active zone for transporting an item, at least one sensor, and a non-programmable controller responsive to detection signals from the sensor, said non-programmable controller controlling said second conveyor module to pass an item from one end of the second module to the other.

2. The system of claim 1 wherein said non-programmable controller further controls said second conveyor module to deactivate a zone which does not contain an item to transport, and to accumulate an item in a zone when the next zone in the direction of transport already contains an item in that zone.

3. The system of claim 1 wherein said selectively actuable device is a drive roller.

4. The system of claim 2 further comprising a plurality of active zones, each comprising a drive roller, a plurality of idler rollers, a sensor for sensing an item in the active zone and for generating a detection signal in response thereto, and a mechanism connecting the drive roller to the idler rollers so that actuation of the drive roller actuates the idler rollers, wherein the drive roller and idler rollers are disposed to define a substantially planar conveying surface.

5. The system of claim 1 wherein the second conveyor module comprises a plurality of active zones, each active zone comprising a drive roller, a plurality of idler rollers, a sensor for sensing an item in the active zone and for generating a detection signal in response thereto, and a mechanism connecting the drive roller to the idler rollers so that actuation of the drive roller actuates the idler rollers, wherein the drive roller and idler rollers are disposed to define a substantially planar conveying surface contiguous with the surface of the first module.

6. The system of claim 4 wherein the programmable controller comprises a motherboard including a microprocessor and a motor control board for controlling actuation of each drive roller of the first module.

7. The system of claim 1 wherein the programmable controller comprises a motherboard including an I/O board for receiving signals from the sensor.

8. The system of claim 1 wherein the programmable controller comprises a motherboard including a communications interface for programming the controller with a logic scheme.

9. The system of claim 3 wherein the programmable controller comprises an integral modular unit for controlling the functions of the first conveyor module, including a microprocessor, a motor control board for controlling actuation of each drive roller of the first module, an I/O board for receiving signals from the sensors and a communications interface.

10. The system of claim 5 wherein the second conveyor module further comprises a sensor assembly for each zone, each sensor assembly being interconnected to an adjacent sensor to form a modular control unit, the modular control unit controlling the active zones of the second module according to a predetermined logic scheme.

11. The system of claim 1 further comprising a scanner positioned to scan an item before the item reaches the first module, said scanner connected to the programmable controller.

12. The system of claim 1 wherein said first conveyor module includes a main path and a divert path which branches from the main path, said selectively actuable device being a divert mechanism which can be selectively actuated to cause an item on the main path to be diverted to the divert path, said programmable controller controlling operation of the divert mechanism.

13. The system of claim 2 wherein the first conveyor module includes a plurality of selectively actuable devices for transporting an item, each of said actuable devices defining an active zone, each active zone comprising a drive roller, a plurality of idler rollers, a sensor for sensing an item in the active zone and for generating a detection signal in response thereto, and a mechanism connecting the drive roller to the idler rollers so that actuation of the drive roller actuates the idler rollers, wherein the drive roller and idler rollers are disposed to define a substantially planar conveying surface.

14. The system of claim 1 wherein the programmable controller is connected to receive inputs from each of the sensors and functions to implement zone logic.

15. The system of claim 12 further comprising a scanner positioned to scan an item before the item reaches the divert branch of the first module, said scanner connected to the programmable controller, whereby scanned information is used to determine whether the item is diverted to the divert path or allowed to pass along the main path.

16. The system of claim 12 further including a third and fourth module, said third module connected to receive items from the main path of the first module and said fourth module connected to receive items from the divert path of the first module, each of the third and fourth modules controlled with a non-programmable controller responsive to detection signals from one or more sensors, said controllers implementing zone logic to pass an item from one end of the respective module to the other, to deactivate a zone which does not contain an item to transport, and to accumulate an item in a zone when the next zone in the direction of transport already contains an item in that zone.

17. The system of claim 12, further comprising a sensing device upstream from the divert path, which senses whether an item is to be directed to the divert path.

18. The system of claim 17 wherein said sensing device is a scale.

19. The system of claim 1 wherein said programmable controller communicates via a Controller Area Network (CAN) bus with another programmable controller on a third conveyor module.

20. The system of claim 1 wherein said programmable controller communicates via an Actuator Sensor Interface (ASI) bus with another programmable controller on a third conveyor module.

21. A method of controlling a conveyor system comprising:
controlling a first conveyor module with a programmable controller, the first conveyor module including a plurality of selectively actuable active zones for transporting an item, each active zone comprising a drive roller, a plurality of idler rollers, a sensor for sensing an item in the active zone and for generating a detection signal in response thereto, and a mechanism connecting the drive roller to the idler rollers so that actuation of the drive roller actuates the idler rollers, wherein the drive roller and idler rollers are disposed to define a substantially planar conveying surface, the programmable controller responding to detection signals from the sensors to control operation of the active zones according to a programmed logic scheme; and
controlling a second conveyor module disposed adjacent to the first conveyor module with a non-programmable controller, the second conveyor module including a plurality of selectively actuable active zones for transporting an item received from the first conveyor module, each zone comprising a drive roller, a plurality of idler rollers, a sensor for sensing an item in the active zone and for generating a detection signal in response thereto, and a mechanism connecting the drive roller to the idler rollers so that actuation of the drive roller actuates the idler rollers, wherein the drive roller and idler rollers are disposed to define a substantially planar conveying surface contiguous with the surface of the first module, the non-programmable controller controlling each zone in response to detection signals from one or more of the sensors, said non-programmable controller implementing zone logic to pass an item from one end of the second module to another end therof to deactivate a zone which does not contain an item to transport, and to accumulate an item in a zone when the next zone in the direction of transport already contains an item.

22. A modular controller for a roller type conveyor module including at least one active zone, comprising:
a motherboard comprising a microcomputer based control, said microcomputer based control defining a particular communications architecture, said motherboard further comprising a plurality of connectors connecting said control with daughterboards;
a plurality of daughterboards disposed on the motherboard and joined with said connectors, the plurality of daughterboards including at least one motor control board for controlling an active zone of the roller type conveyor, an I/O daughterboard for interfacing with sensors, a communications interface and a microprocessor;
said communications architecture being interchangeable among at least two different control architectures; and
the modular controller controlling all of the functions of the roller type conveyor module.

23. The modular controller of claim 22 wherein the motor control board comprises a brush type motor controller.

24. The modular controller of claim 22 wherein the motor control board comprises a brushless type motor controller.

25. The modular controller of claim 22 wherein the communications interface comprises an RS232 interface.

26. The modular controller of claim 22 wherein the microprocessor is programmable via the RS232 interface.

27. The modular controller of claim 22 wherein said motherboard further includes a Controller Area Network (CAN) interface.

28. The modular controller of claim 22 wherein said motherboard further includes an Actuator Sensor Interface (ASI).

29. A controller for a conveyor module having a conveying surface and at least one sensor for sensing the presence of an article on the conveying surface comprising:
a motherboard having a particular communications architecture adapted to control the movement of an article on the conveying surface based at least partially on information received from the sensor; and
a daughterboard attached to said motherboard, said daughterboard adapted to communicate with a driver that drives said conveying surface based upon instructions received from said motherboard, said daughterboard being configured to be physically and electrically attached to one of either a first or a second type of motherboard, said first and second types of motherboards having different communications architectures.

30. The controller of claim 29 wherein said first type of motherboard is a non-programmable motherboard and said second type of motherboard is a programmable motherboard.

31. The controller of claim 29 wherein said daughterboard includes a universal header pin interface adapted to interface with pins on either of said first and second types of motherboards.

32. The controller of claim 29 wherein said motherboard is adapted to communicate with at least one other motherboard located on another conveyor module.

33. The controller of claim 32 wherein said first type of motherboard is adapted to communicate with at least one other motherboard located on another conveyor module via a Controller Area Network (CAN) bus, and said second type of motherboard is adapted to communicate with at least one other motherboard located on another conveyor module via an Actuator Sensor Interface (ASI) interface.

34. The controller of claim 29 wherein said driver is a motor attached to a drive roller on said modular conveyor.

35. The controller of claim 34 wherein said drive roller is connected to a plurality of idler rollers that are driven when said drive roller is driven by said motor.

36. The controller of claim 29 further including a plurality of daughterboards adapted to communicate with and receive instructions from said motherboard, each of said plurality of daughterboards being configured to be physically and electrically attached to either of said first or said second types of motherboards.

37. The controller of claim 36 wherein at least one of said plurality of daughterboards is adapted to communicate with a divert mechanism for diverting at least some articles on the modular conveyor conveying surface onto a divert conveyor.

38. The controller of claim 29 wherein said conveyor module includes a plurality of zones, each of said zones being able to move an article in that zone independently of articles in other zones, said motherboard adapted to control each of said zones independently.

39. The controller of claim 33 wherein said conveyor module includes a plurality of zones, each of said zones being able to move an article in that zone independently of articles in other zones, said motherboard adapted to control each of said zones independently.

40. A method of manufacturing a controller for a conveyor module having a conveying surface and at least one sensor for sensing the presence of an article on the conveying surface comprising:
providing at least one daughterboard that communicates with a driver that drives said conveying surface;
selecting from at least a first type and a second type of motherboard, said first and second types having substantially different communications architectures, said first and second types of motherboards being adapted to control the movement of an article on the conveying surface by issuing signals to said daughterboard, said signals being based at least partially on information received from the sensor;
attaching said selected motherboard to the conveyor module; and
attaching said at least one daughterboard to said selected motherboard, said daughterboard being adapted to be attached to either of said first or said second types of motherboards.

41. The method of claim 41 further including attaching a plurality of daughterboards to said selected motherboard, each of said plurality of daughterboards adapted to communicate with a separate driver that drives a separate zone of said conveyor module.

42. The method of claim 40 further including providing a universal header pin interface on said daughterboard adapted to interface with pins on either of said first and second types of motherboards.

43. The method of claim 42 wherein said first type of motherboard is a programmable motherboard and said second type of motherboard is a non-programmable motherboard.

44. The method of claim 42 wherein said first type of motherboard is adapted to communicate with at least one other motherboard located on another conveyor module via a Controller Area Network (CAN) bus, and said second type of motherboard is adapted to communicate with at least one other motherboard located on another conveyor module via an Actuator Sensor Interface (ASI) interface.

45. The method of claim 43 wherein said non-programmable motherboard is selected and further including coupling a programmable logic controller to said non-programmable motherboard, said programmable logic controller adapted to communicate with at least one other programmable logic controller coupled to another non-programmable motherboard.

46. A conveyor system comprising:
a plurality of first conveyor modules each having a controller adapted to control the movement of articles on the respective first conveyor modules, each of said controllers adapted to communicate with another first conveyor module controller via a first type of communications bus; and
a plurality of second conveyor modules each having a controller adapted to control the movement of articles on the respective second conveyor modules, each of said controllers adapted to communicate with another second conveyor module controller via a second type of communications bus, said second type of communications bus being different from said first type.

47. The system of claim 46 wherein said first type of communications bus is an Actuator Sensor Interface (ASI) bus and said second type of communications bus is a Controlled Area Network (CAN) bus.

48. The system of claim 47 further including a plurality of third conveyor modules each having a controller adapted to control movement of articles on the respective third conveyor modules, each of said controllers adapted to communicate with another third conveyor module controller via a third type of communications bus, said third type of communications bus being different from either of said first or second communications busses.
